(19) United States
(12) Patent Application Publication
(10) Pub. No.: US 2026/0096515 A1
(43) Pub. Date: Apr. 9, 2026

(54) BALE WRAP MONITORING SYSTEM FOR AN AGRICULTURAL HARVESTER

(71) Applicant: CNH Industrial America LLC, New Holland, PA (US)

(72) Inventors: Malachi Spencer McMullen, Birdsboro, PA (US); Daniel Dallman, Eldridge, IA (US); Douglas J. Bollin, Port Byron, IL (US)

(21) Appl. No.: 19/352,737

(22) Filed: Oct. 8, 2025

Related U.S. Application Data
(60) Provisional application No. 63/704,902, filed on Oct. 8, 2024.

(51) Int. Cl. A01F 15/07; B65B 11/04; B65B 41/16; B65B 57/02; B65B 57/18; G01D 21/02

(52) U.S. Cl. CPC A01F 15/0715; B65B 11/04; B65B 41/16; B65B 57/02; B65B 57/18; G01D 21/02; A01F 2015/074; A01F 2015/076

(57) ABSTRACT

A bale wrap monitoring system for an agricultural harvester includes a controller having a processor and a memory. The controller is configured to receive a sensor signal from a sensor indicative of presence of a bale wrap on a bale of agricultural product, and the sensor is directed toward the bale. Furthermore, the controller is configured to determine the bale wrap is present on the bale based on feedback from the sensor. The controller is also configured to output a bale wrap presence signal in response to determining the bale wrap is present on the bale.

### CROSS-REFERENCE TO RELATED APPLICATION

This application claims priority from and the benefit of U.S. Provisional Application Ser. No. 63/704,902, entitled “BALE WRAP MONITORING SYSTEM FOR AN AGRICULTURAL HARVESTER”, filed Oct. 8, 2024, which is hereby incorporated by reference in its entirety.

### BACKGROUND

The present disclosure relates generally to a bale wrap monitoring system for an agricultural harvester.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a bale wrap monitoring system for an agricultural harvester includes a controller having a processor and a memory. The controller is configured to receive a sensor signal from a sensor indicative of presence of a bale wrap on a bale of agricultural product, and the sensor is directed towards the bale. Furthermore, the controller is configured to determine the bale wrap is present on the bale based on feedback from the sensor. The controller is also configured to output a bale wrap presence signal in response to determining the bale wrap is present on the bale.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having an agricultural product transport assembly and a baler.

FIG. 2 is a schematic view of an embodiment of an agricultural product transport assembly and an embodiment of a baler that may be employed within the agricultural harvester of FIG. 1.

FIG. 3 is a block diagram of an embodiment of a bale wrap monitoring system that may be employed within the baler of FIG. 2.

FIG. 4 is a perspective view of an embodiment of a sensor housing and an embodiment of a sensor that may be employed within the bale wrap monitoring system of FIG. 3.

FIG. 5 is another perspective view of the sensor housing and the sensor of FIG. 4.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

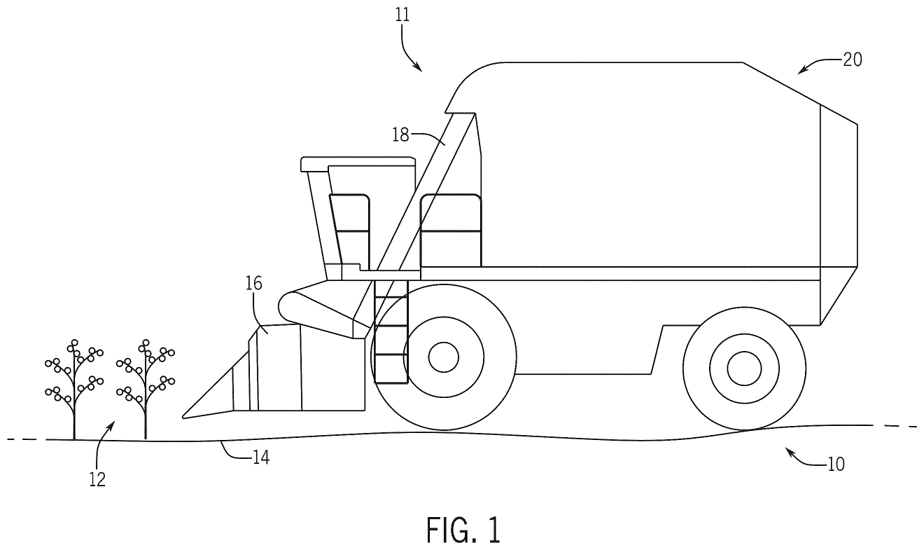

FIG. 1 is a side view of an embodiment of an agricultural harvester 10 (e.g., harvester, agricultural harvester) having an agricultural product transport assembly 11 and a baler. The agricultural harvester 10 is configured to harvest agricultural product 12 (e.g., cotton) from a field 14 and to form the agricultural product 12 into bales (e.g., agricultural bales). In the illustrated embodiment, the agricultural harvester 10 includes a header 16 having row units that harvest the agricultural product 12 from the field 14. Additionally, the agricultural product transport assembly 11 of the agricultural harvester 10 includes an air-assisted conveying system 18 that moves the agricultural product 12 from the row units of the header 16 to an accumulator assembly of the agricultural product transport assembly 11. The agricultural product transport assembly 11 also includes a conveying system that conveys the agricultural product 12 from the accumulator assembly into the baler 20 (e.g., agricultural baler). The baler 20 is supported by and/or mounted within or on a chassis of the agricultural harvester 10. The baler 20 may form the agricultural product 12 into round bales. However, in other embodiments, the baler 20 of the agricultural harvester 10 may form the agricultural product into square bales, polygonal bales, or bales of other suitable shape(s). After forming the agricultural product 12 into a bale, a bale wrapping system of the agricultural harvester 10 wraps the bale with a bale wrap to secure the agricultural product 12 within the bale and to generally maintain a shape of the bale.

In certain embodiments, the agricultural harvester includes a bale wrap monitoring system that determines whether the bale wrap is present on the bale. As discussed in detail below, the bale wrap monitoring system includes a controller having a processor and a memory. The controller is configured to receive a sensor signal from a sensor indicative of presence of a bale wrap on a bale of the agricultural product. The sensor is directed towards the bale. Furthermore, the controller is configured to determine the bale wrap is present on the bale based on feedback from the sensor. The controller is also configured to output a bale wrap presence signal in response to determining the bale wrap is present on the bale. In certain embodiments, the bale wrap presence signal is indicative of instructions to control a user interface to present an indication that the bale wrap is present on the bale. Accordingly, the operator may be informed that the bale is wrapped, thereby enabling the operator to manually activate a bale ejection system to eject the wrapped bale from the baler. Furthermore, in certain embodiments, the bale wrap presence signal is indicative of instructions to control the bale ejection system to eject the wrapped bale from the baler. Accordingly, the wrapped bale may be ejected from the baler without operator input, thereby enhancing the efficiency of the baling process.

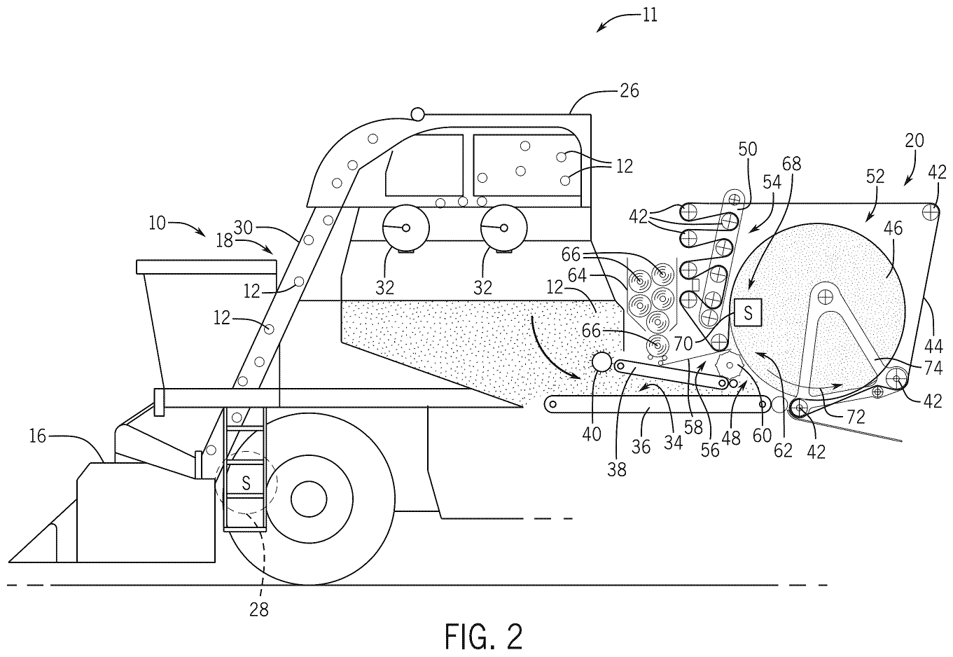

FIG. 2 is a schematic view of an embodiment of an agricultural product transport assembly 11 and an embodiment of a baler 20 that may be employed within the agricultural harvester 10 of FIG. 1. As previously discussed, the header 16 of the agricultural harvester 10 includes row units that harvest the agricultural product 12 (e.g., cotton) from the field. Furthermore, the air-assisted conveying system 18 is configured to move the agricultural product 12 from the row units of the header 16 to the accumulator assembly 26. In the illustrated embodiment, the air-assisted conveying system 18 includes a conveying air source 28 that outputs a conveying air flow through one or more ducts 30. Each duct 30 receives the agricultural product 12 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 that distribute the agricultural product 12 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport assembly 11 includes a first belt (e.g., belt) 36 that moves the agricultural product 12 from the accumulator assembly 26 to the baler 20. The first belt 36 rotates in a first rotational direction to move an agricultural product engaging surface of the first belt 36 toward the baler 20. Furthermore, in the illustrated embodiment, the conveying system 34 includes a second belt 38 positioned on an opposite side of the agricultural product 12 from the first belt 36, and the second belt 38 cooperates with the first belt 36 to move the agricultural product 12 from the accumulator assembly 26 to the baler 20. Furthermore, in the illustrated embodiment, the conveying system 34 includes an agitation roller 40 positioned upstream of the second belt 38. The agitation roller 40 agitates the agricultural product 12 entering the pair of opposing belts, thereby enhancing the uniformity of the distribution of the agricultural product passing through the pair of opposing belts.

In the illustrated embodiment, the baler 20 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 12 from the conveying system 34 and draws the agricultural product 12 into a cavity 48, where the agricultural product 12 is gradually built up to form the bale 46.

In the illustrated embodiment, the baler 20 includes a tension arm 50 that establishes tension within the belt(s) 44. As the agricultural product 12 builds within the cavity 48, the agricultural product 12 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 20) and rollers 42 coupled to the tension arm 50, which is pivotable relative to the fixed rollers 42 (e.g., relative to the housing/frame of the baler 20). Accordingly, as the agricultural product 12 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more rollers and/or one or more belts of a bale wrap feeding assembly. The roller(s) and/or the belt(s) drive the bale wrap 58 toward a starter roller 60 (e.g., bale wrap feeder). The starter roller 60 rotates to feed the bale wrap 58 into the cavity 48 of the baler 20 at a feeding location 62, thereby driving the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 20, and the process of forming a subsequent bale may be initiated. While the starter roller 60 feeds the bale wrap 58 into the cavity 48 in the illustrated embodiment, in other embodiments, the agricultural harvester may include another suitable bale wrap feeder that feeds the bale wrap into the cavity. For example, in certain embodiments, the agricultural harvester may include a movable wrap guide (e.g., duck bill) that engages the bale wrap while the movable wrap guide is in a first position and to move to a second position to feed the bale wrap into the cavity at the feeding location.

In certain embodiments, during the harvesting process, the conveying system 34 and the baler 20 may be periodically activated to transfer the agricultural product 12 from the accumulator assembly 26 to the baler 20 and to form the bale 46. For example, as the agricultural harvester 10 traverses a field, the agricultural product 12 may accumulate within the accumulator assembly 26. After a selected duration, the conveying system 34 may be activated to transfer the agricultural product 12 from the accumulator assembly 26 to the baler 20. For example, the conveying system 34 may move the agricultural product 12 toward the baler 20 at a significantly faster rate than the air-assisted conveying system 18 moves the agricultural product 12 into the accumulator assembly 26. Concurrently with activation of the conveying system 34, the baler 20 may be activated to initiate the bale forming process, as described above. After another selected duration, the conveying system 34 and the baler 20 may be deactivated to enable the accumulator assembly 26 to collect additional agricultural product 12. In certain embodiments, the conveying assembly 34 and the baler 20 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 20 are periodically activated, the agricultural harvester 10 may utilize less energy during the harvesting process (e.g., as compared to continuously operating the conveying system and the baler).

In the illustrated embodiment, the agricultural harvester 10 includes a bale wrap assembly storage compartment 64 that stores multiple bale wrap assemblies 66. In certain embodiments, each bale wrap assembly 66 includes a shaft and a bale wrap disposed about the shaft to form a roll of the bale wrap. However, in other embodiments, the shaft may be omitted, and the bale wrap may be arranged in a roll (e.g., with a hollow region at the center).

As discussed in detail below, the agricultural harvester 10 includes a bale wrap monitoring system 68 having a sensor 70 directed towards the bale 46 within the cavity 48 of the baler 20. The sensor 70 outputs a sensor signal indicative of presence of the bale wrap 58 on the bale 46. The bale wrap monitoring system 68 also includes a controller communicatively coupled to the sensor 70. The controller includes a processor and a memory, and the controller is configured to receive the sensor signal from the sensor 70. The controller is also configured to determine the bale wrap 58 is present on the bale 46 based on feedback from the sensor 70. Furthermore, the controller is configured to output a bale wrap presence signal in response to determining the bale wrap 58 is present on the bale 46. In certain embodiments, the bale wrap presence signal is indicative of instructions to control a user interface to present an indication that the bale wrap is present on the bale. Accordingly, the operator may be informed that the bale is wrapped, thereby enabling the operator to manually activate a bale ejection system to eject the wrapped bale from the cavity of the baler. Furthermore, in certain embodiments, the bale wrap presence signal is indicative of instructions to control the bale ejection system to eject the wrapped bale from the baler. Accordingly, the wrapped bale may be ejected from the baler without operator input, thereby enhancing the efficiency of the baling process.

In the illustrated embodiment, the sensor 70 is disposed within the baler 20 proximate to the feeding location 62, and the sensor 70 is directed towards a portion of the bale 46 immediately upstream of the feeding location 62 with respect to a path 72 of the bale wrap 58 around the bale 46. Accordingly, the sensor 70 may monitor presence of the bale wrap 58 on the bale 46 at a location that indicates the bale wrap 58 substantially circumscribes the bale 46. As used herein, “immediately upstream” of the feeding location with respect to the path of the bale wrap around the bale refers to a location that is at least 345 degrees around the bale from the feeding location along the path of the bale wrap around the bale (e.g., less than or equal to 15 degrees from the feeding location along the circumference of the bale). While the sensor 70 is disposed within the baler 20 proximate to the feeding location 62 in the illustrated embodiment, in other embodiments, the sensor may be disposed at another suitable location within the agricultural harvester. Furthermore, while the sensor 70 is directed towards a portion of the bale 46 immediately upstream of the feeding location 62 with respect to the path 72 of the bale wrap 58 around the bale 46 in the illustrated embodiment, in other embodiments, the sensor 70 may be directed towards another suitable portion of the bale.

Furthermore, in certain embodiments, the bale ejection system may include one or more actuators that drive pendulum arms 74 of the baler 20 to rotate upwardly from the illustrated bale formation position to a bale ejection position. As the pendulum arms 74 rotate upwardly toward the bale ejection position, the rollers 42 coupled to the pendulum arms 74 move the belt(s) at a rear portion of the baler 20, thereby forming a gap sufficiently large for the wrapped bale to exit the cavity 48 of the baler 20. In addition, the tension within the belt(s) 44, which is established by the tension arm 50, causes the belt(s) to drive the wrapped bale out of the cavity 48 as the pendulum arms 74 rotate upwardly. Accordingly, the wrapped bale is ejected from the cavity 48 of the baler 20 as the pendulum arms 74 rotate from the illustrated bale formation position to the bale ejection position. While a bale ejection system having actuator(s) that drive the pendulum arms 74 to rotate is disclosed above, in certain embodiments, the bale ejection system may include any other suitable device(s) that can eject the bale from the cavity, such as one or more actuators to drive a door positioned at a rear of the baler to open.

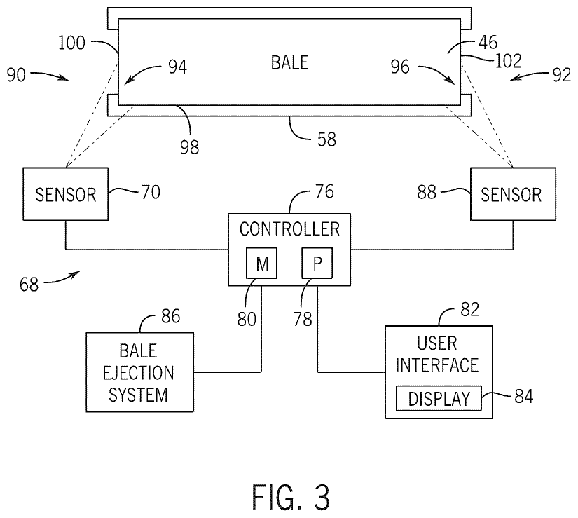

FIG. 3 is a block diagram of an embodiment of a bale wrap monitoring system 68 that may be employed within the baler of FIG. 2. As previously discussed, the sensor 70 of the bale wrap monitoring system 68 is directed towards the bale 46 within the cavity of the baler of the agricultural harvester. In addition, the sensor 70 outputs a sensor signal indicative of presence of the bale wrap 58 on the bale 46. The sensor 70 may include any suitable type(s) of sensing device(s) that monitor the presence of the bale wrap 58 on the bale 46. For example, in certain embodiments, the sensor 70 includes an ultrasonic sensor that emits an ultrasonic signal toward the bale and to receive a return ultrasonic signal. Due to the difference in ultrasonic reflectivity between the agricultural product (e.g., cotton) of the bale and the bale wrap (e.g., plastic bale wrap), the ultrasonic sensor outputs the sensor signal indicative of presence of the bale wrap on the bale. For example, the ultrasonic sensor may output a sensor signal indicative of presence of the bale wrap on the bale in response to receiving a return ultrasonic signal having a magnitude greater than a threshold value (e.g., which indicates that the emitted ultrasonic signal reflected off the higher ultrasonic reflectivity bale wrap, as compared to the lower ultrasonic reflectivity agricultural product). In addition, in certain embodiments, the sensor 70 includes a color contrast sensor that monitors a difference in color between the bale wrap and the agricultural product within the bale. Due to the difference in color, the color contrast sensor outputs the sensor signal indicative of presence of the bale wrap on the bale. Furthermore, in certain embodiments, the sensor may include a camera, an infrared sensor, a LiDAR sensor, a radar sensor, a millimeter wave sensor, a terahertz sensor, other suitable type(s) of sensing device(s), or a combination thereof (e.g., alone or in combination with the ultrasonic sensor and/or the color contrast sensor).

In the illustrated embodiment, the bale wrap monitoring system 68 includes a controller 76 communicatively coupled to the sensor 70. In certain embodiments, the controller 76 is an electronic controller having electrical circuitry that receives the sensor signal from the sensor 70. In the illustrated embodiment, the controller 76 includes a processor 78, such as a microprocessor, and a memory device 80. The controller 76 may also include one or more storage devices and/or other suitable components. The processor 78 may be used to execute software, such as software for receiving the sensor signal from the sensor 70, and so forth. Moreover, the processor 78 may include multiple microprocessors, one or more “general-purpose” microprocessors, one or more special-purpose microprocessors, and/or one or more application specific integrated circuits (ASICs), or some combination thereof. For example, the processor 78 may include one or more reduced instruction set (RISC) processors.

The memory device 80 may include a volatile memory, such as random access memory (RAM), and/or a nonvolatile memory, such as read-only memory (ROM). The memory device 80 may store a variety of information and may be used for various purposes. For example, the memory device 80 may store processor-executable instructions (e.g., firmware or software) for the processor 78 to execute, such as instructions for receiving the sensor signal from the sensor 70, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for receiving the sensor signal from the sensor 70, etc.), and any other suitable data.

In the illustrated embodiment, the bale wrap monitoring system 68 includes a user interface 82 communicatively coupled to the controller 76. The user interface 82 receives input from an operator and provides information to the operator. The user interface 82 may include any suitable input device(s) for receiving input, such as a keyboard, a mouse, button(s), switch(es), knob(s), other suitable input device(s), or a combination thereof. In addition, the user interface 82 may include any suitable output device(s) for presenting information to the operator, such as speaker(s), indicator light(s), other suitable output device(s), or a combination thereof. In the illustrated embodiment, the user interface 82 includes a display 84 that presents visual information to the operator. In certain embodiments, the display 84 may include a touchscreen interface that receives input from the operator.

In response to receiving the sensor signal indicative of presence of the bale wrap 58 on the bale 46, the controller 76 determines the bale wrap 58 is present on the bale 46 based on feedback from the sensor 70. For example, the controller 76 may determine the bale wrap 58 is present on the bale 46 in response to receiving a sensor signal from an ultrasonic sensor indicative of a return ultrasonic signal magnitude greater than a threshold magnitude (e.g., because the ultrasonic reflectivity of the bale wrap 58 is greater than the ultrasonic reflectivity of the agricultural product of the bale 46). Furthermore, the controller 76 may determine the bale wrap 58 is present on the bale 46 in response to receiving a sensor signal from a color contrast sensor indicative of a difference in color greater than a threshold color contrast (e.g., because the bale wrap 58 and the agricultural product of the bale 46 have different colors). In addition, in certain embodiments, the controller may determine the bale wrap is present on the bale in response to receiving a sensor signal from a camera indicative of an image corresponding to presence of the bale wrap on the bale. Furthermore, in certain embodiments, the controller may determine the bale wrap is present on the bale in response to receiving a sensor signal from a LiDAR sensor, an infrared sensor, a millimeter wave sensor, or a terahertz sensor indicative of a return signal corresponding to the presence of the bale wrap on the bale (e.g., because the reflectivity of the bale wrap is different than the reflectivity of the agricultural product of the bale).

In response to determining the bale wrap 58 is present on the bale 46, the controller 76 outputs a bale wrap presence signal. In certain embodiments, the bale wrap presence signal is indicative of instructions to control the user interface 82 to present an indication that the bale wrap 58 is present on the bale 46. For example, the controller 76 may instruct the display 84 of the user interface 82 to present a visual indication that the bale wrap 58 is present on the bale 46. Furthermore, in certain embodiments, the bale wrap presence signal is indicative of instructions to control the bale ejection system 86 to eject the wrapped bale from the baler. For example, as previously discussed, the bale ejection system may include one or more actuators that drive the pendulum arms of the baler to rotate from the bale formation position to the bale ejection position, thereby ejecting the wrapped bale from the baler. In certain embodiments, the bale wrap presence signal is indicative of instructions to control the user interface alone, the bale wrap presence signal is indicative of instructions to control the bale ejection system alone, or the bale wrap presence signal is indicative of instructions to control the user interface and the bale ejection system.

Furthermore, in certain embodiments, the bale wrap presence signal may be indicative of instructions to control another suitable component of the baler (e.g., a bale handler that receives the bale from the cavity of the baler, a drive system of the agricultural harvester, the conveying system of the agricultural product transport assembly, the air-assisted conveying system, etc.). In addition, in certain embodiments, the controller may be configured to enable manual control of the bale ejection system to eject the wrapped bale from the baler in response to determining the bale wrap is present on the bale. For example, the bale ejection system may be manually controlled via the user interface to eject the wrapped bale from the baler. However, during operation of the agricultural harvester, the controller may disable manual control of the bale ejection system with regard to ejecting the wrapped bale from the baler (e.g., the bale ejection control(s) on the user interface maybe disabled). In response to determining the bale wrap is present on the bale, the controller may enable manual control of the bale ejection system with regard to ejecting the wrap bale from the baler. As a result, the operator may provide an input to the user interface indicative of instructions to eject the bale, the user interface may output the instructions to the controller, and the controller may control the bale ejection system to eject the wrapped bale from the baler.

In certain embodiments, the sensor 70 outputs the sensor signal indicative of presence of the bale wrap 58 on the bale 46 and a number of layers of the bale wrap 58 over the agricultural product of the bale 46. In such embodiments, the controller 76 is configured to determine the bale wrap 58 is present on the bale 46 in response to determining the number of layers of the bale wrap 58 is equal to a target number of layers (e.g., 1, 2, 3, 4, 5, 6, 7, 8, or more). Accordingly, the operator may be informed that the bale is wrapped and/or the bale ejection system may eject the wrapped bale from the baler in response to the controller determining the target number of layers of the bale wrap are present on the bale. In embodiments in which the sensor 70 includes an ultrasonic sensor, the ultrasonic sensor may monitor the number of layers based on the return ultrasonic signal magnitude (e.g., because the reflectivity of the bale wrap may increase with the number of layers). Furthermore, in embodiments in which the sensor 70 includes a color contrast sensor, the color contrast sensor may monitor the number of layers based on the color contrast (e.g., the color contrast between the agricultural product and the bale wrap may increase as the number of layers increases). In addition, in embodiments in which the sensor 70 includes a LiDAR sensor, an infrared sensor, a millimeter wave sensor, or a terahertz sensor, the respective sensor may monitor the number of layers based on the respective return signal (e.g., because the reflectivity of the bale wrap may increase with the number of layers).

In the illustrated embodiment, the bale wrap monitoring system 68 includes a second sensor 88 communicatively coupled to the controller 76. The second sensor 88 outputs a second sensor signal indicative of presence of the bale wrap 58 on the bale 46. The controller 76 is configured to receive the second sensor signal from the second sensor 88, and the controller 76 is configured to determine the bale wrap 58 is present on the bale 46 based on feedback from the sensor 70 and the second sensor 88. The second sensor 88 may include any suitable type(s) of sensing device(s) that monitor the presence of the bale wrap 58 on the bale 46. For example, in certain embodiments, the second sensor 88 may include an ultrasonic sensor, a color contrast sensor, a camera, an infrared sensor, a LiDAR sensor, a radar sensor, a millimeter wave sensor, a terahertz sensor, other suitable type(s) of sensing device(s), or a combination thereof. In certain embodiments, the sensor 70 and the second sensor 88 may include the same type(s) of sensing device(s). However, in other embodiments, the sensor and the second sensor may include different type(s) of sensing device(s).

As illustrated, the sensor 70 is directed towards a first portion 90 of the bale 46, and the second sensor 88 is directed towards a second portion 92 of the bale 46. Accordingly, the sensors monitor presence of the bale wrap at different locations on the bale, thereby enabling the controller to determine whether both portions of the bale are wrapped with the bale wrap. For example, if the controller 76 determines that the bale wrap 58 is present at the first portion 90 based on feedback from the sensor 70, and the controller 76 determines that the bale wrap 58 is not present at the second portion 92 based on feedback from the second sensor 88, the controller 76 may determine that the bale wrap 58 is not present on the bale 46 because the bale wrap 58 does not cover both portions of the bale 46. However, if the controller 76 determines that the bale wrap 58 is present at the first portion 90 based on feedback from the sensor 70, and the controller 76 determines that the bale wrap 58 is present at the second portion 92 based on feedback from the second sensor 88, the controller 76 may determine that the bale wrap 58 is present on the bale 46 because the bale wrap 58 covers both portions of the bale 46.

In certain embodiments, the second sensor 88 is disposed within the baler proximate to the feeding location. Furthermore, in certain embodiments, the first portion 90 is positioned immediately upstream of the feeding location with respect to the path of the bale wrap 58 around the bale 46, and the second portion 92 is positioned immediately upstream of the feeding location with respect to the path of the bale wrap 58 around the bale 46. Accordingly, the sensors may monitor presence of the bale wrap 58 on the bale 46 at locations that indicate the bale wrap 58 substantially circumscribes the bale 46. While each sensor is disposed within the baler proximate to the feeding location in certain embodiments, in other embodiments, at least one sensor (e.g., each sensor) may be disposed at another suitable location within the agricultural harvester. Furthermore, while each sensor is directed towards a portion of the bale 46 immediately upstream of the feeding location with respect to the path of the bale wrap 58 around the bale 46 in certain embodiments, in other embodiments, at least one sensor (e.g., each sensor) may be directed towards another suitable portion of the bale.

In the illustrated embodiment, the first portion 90 is positioned at a first longitudinal end portion 94 of the bale 46, and the second portion 92 is positioned at a second longitudinal end portion 96 of the bale 46, opposite the first longitudinal end portion 94. Accordingly, if the controller 76 determines that the bale wrap 58 is present at the first portion 90 based on feedback from the sensor 70, and the controller 76 determines that the bale wrap 58 is present at the second portion 92 based on feedback from the second sensor 88, the controller 76 may determine that the bale wrap 58 extends across an entire longitudinal extent of the bale 46, thereby determining that the bale wrap 58 is present on the bale 46. While the first portion 90 is positioned at the first longitudinal end portion 94 and the second portion 92 is positioned at the second longitudinal end portion 96 in the illustrated embodiment, in other embodiments, the first portion may be positioned at another suitable portion of the bale and/or the second portion may be positioned at another suitable portion of the bale.

In certain embodiments, the sensor 70 outputs the sensor signal indicative of presence of the bale wrap 58 on the bale 46 and the number of layers of the bale wrap 58 over the agricultural product of the bale 46 at the first portion 90. In addition, the second sensor 88 also outputs the second sensor signal indicative of presence of the bale wrap 58 on the bale 46 and the number of layers of the bale wrap 58 over the agricultural product of the bale 46 at the second portion 92. In such embodiments, the controller 76 is configured to determine the bale wrap 58 is present on the bale 46 in response to determining the number of layers of the bale wrap 58 at the first portion 90 is equal to the target number of layers (e.g., 1, 2, 3, 4, 5, 6, 7, 8, or more) and the number of layers of the bale wrap 58 at the second portion 92 is equal to the target number of layers. Furthermore, in certain embodiments, only one sensor (e.g., the sensor or the second sensor) may monitor the number of layers of the bale wrap (e.g., while the other sensor only monitors presence of the bale wrap on the bale). In such embodiments, the controller may determine the bale wrap is present on the bale in response to determining the bale wrap is present at one portion of the bale and the number of layers is equal to the target number of layers at the other portion of the bale.

In the illustrated embodiment, the first portion 90 includes a portion of a circumferential side 98 of the bale 46 and a portion of a first longitudinal side 100 of the bale 46, and the second portion 92 includes a portion of the circumferential side 98 of the bale 46 and a portion of a second longitudinal side 102 of the bale 46. Accordingly, each sensor monitors presence of the bale wrap 58 on the circumferential side 98 and on the respective longitudinal side. As such, in embodiments in which the bale wrap 58 extends onto the longitudinal sides of the bale 46, the controller may determine the bale wrap is present on the bale in response to determining the bale wrap is present on the circumferential side 98 and the first longitudinal side 100 at the first portion 90 based on feedback from the sensor 70 and on the circumferential side 98 and the second longitudinal side 102 at the second portion 92 based on feedback from the second sensor 88. If the bale wrap is not present on at least one longitudinal side of the bale, the controller may determine that the bale wrap is not present on the bale. However, in embodiments in which the bale wrap does not extend onto the longitudinal sides, the controller may determine whether the bale wrap is present on the bale in response to determining the bale wrap is present on the circumferential side at each of the first and second portions.

While the bale wrap monitoring system 68 includes two sensors in the illustrated embodiment, in other embodiments, the bale wrap monitoring system may include more or fewer sensors. For example, in certain embodiments, the bale wrap monitoring system may include a single sensor. Furthermore, in certain embodiments, the bale wrap monitoring system may include three or more sensors, in which each sensor monitors a respective portion of the bale. In addition, in certain embodiments, the bale wrap monitoring system may include one or more cameras directed toward the bale and which output signal(s) indicative of image(s) of the bale and/or the bale wrap. In such embodiments, the user interface may receive the signal(s) directly and/or via the controller, and the display of the user interface may present the image(s) to the operator, thereby enabling the operator to verify presence of the bale wrap on the bale.

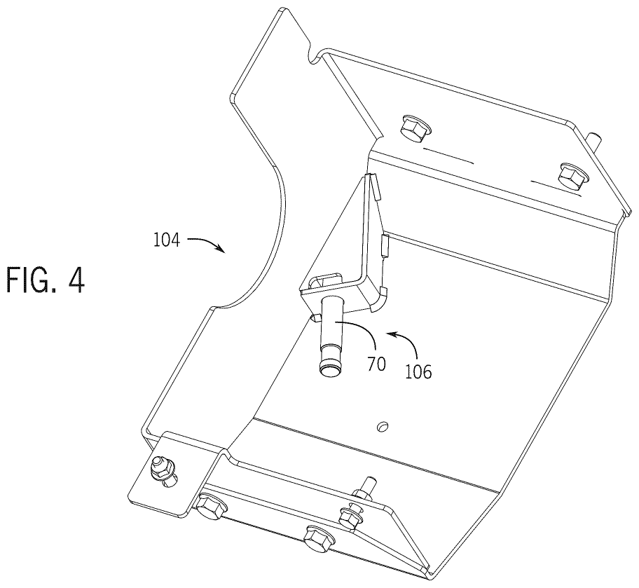

FIG. 4 is a perspective view of an embodiment of a sensor housing 104 and an embodiment of the sensor 70 that may be employed within the bale wrap monitoring system of FIG. 3. In the illustrated embodiment, the sensor housing 104 of the bale wrap monitoring system is configured to support the sensor 70 within the baler of the agricultural harvester. The sensor 70 may be coupled to the housing 104 via any suitable type(s) of connection(s), such as a fastener connection, a threaded connection, at latched connection, etc. Furthermore, in the illustrated embodiment, the housing 104 is disposed about a substantial portion 106 of the sensor 70, thereby blocking material (e.g., agricultural product, dirt, debris, etc.) from contacting the sensor 70 during operation of the agricultural harvester. As used herein, “substantial portion” of the sensor refers to more than 50 percent of the sensor. While the housing is disposed about a substantial portion of the sensor 70 in the illustrated embodiment, in other embodiments, the housing may be disposed about a smaller portion of the sensor.

The housing 104 may have any suitable shape and may be formed from any suitable material(s), such as metal, polymeric material(s), composite material(s), etc. Furthermore, in the illustrated embodiment, an interior of the housing 104 is accessible from an exterior of the baler, thereby enabling the operator to service the sensor 70 (e.g., remove and replace the sensor, adjust the sensor, etc.). In certain embodiments, the housing may include a door positioned at the exterior of the baler, in which the door selectively opens to enable the operator to access the interior of the housing. While the sensor 70 is supported by the housing 104 in the illustrated embodiment, in other embodiments, the housing may be omitted. In such embodiments, the sensor may be supported by another suitable structure (e.g., mount, etc.).

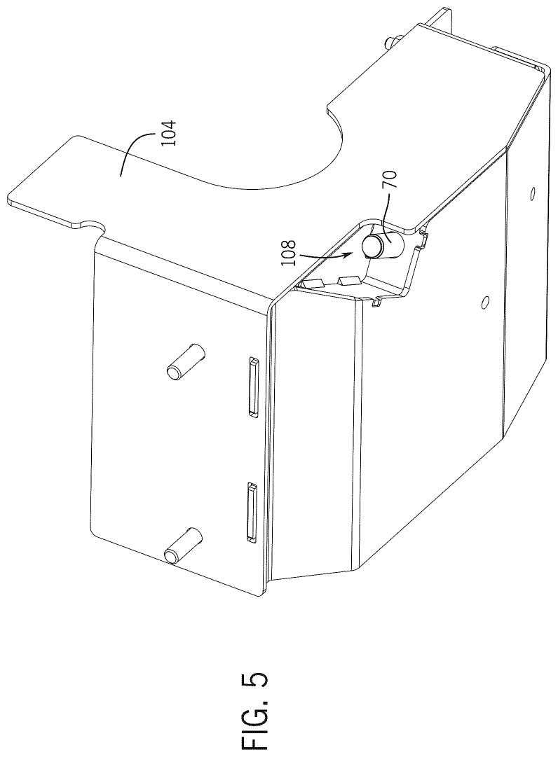

FIG. 5 is another perspective view of the sensor housing 104 and the sensor 70 of FIG. 4. The housing 104 orients the sensor 70, such that the sensor 70 is directed towards the bale. Furthermore, as illustrated, a relatively small portion 108 of the sensor 70 is disposed outside of the housing 104 (e.g., as compared to the substantial portion of the sensor that is disposed within the housing). While the housing 104 disclosed above with regard to FIGS. 4-5 supports the sensor 70, the bale wrap monitoring system may include another housing that supports the second sensor. The features, details, functions, and variations disclosed above with regard to the housing 104 may apply to the housing for the second sensor. For example, in certain embodiments, the housing for the second sensor may mirror the illustrated housing.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A bale wrap monitoring system for an agricultural harvester, comprising:
a controller comprising a processor and a memory, wherein the controller is configured to:
receive a sensor signal from a sensor indicative of presence of a bale wrap on a bale of agricultural product, wherein the sensor is directed towards the bale;
determine the bale wrap is present on the bale based on feedback from the sensor; and
output a bale wrap presence signal in response to determining the bale wrap is present on the bale.

2. The bale wrap monitoring system of claim 1, wherein the bale wrap presence signal is indicative of instructions to control a user interface to present an indication that the bale wrap is present on the bale.

3. The bale wrap monitoring system of claim 1, wherein the bale wrap presence signal is indicative of instructions to control a bale ejection system to eject the bale from a baler of the agricultural harvester.

4. The bale wrap monitoring system of claim 1, wherein the controller is configured to receive a second sensor signal from a second sensor indicative of presence of the bale wrap on the bale, the sensor is directed towards a first portion of the bale, the second sensor is directed towards a second portion of the bale, separate from the first portion of the bale, and the controller is configured to determine the bale wrap is present on the bale based on feedback from the sensor and the second sensor.

5. The bale wrap monitoring system of claim 4, wherein the first portion is positioned at a first longitudinal end portion of the bale, and the second portion is positioned at a second longitudinal end portion of the bale, opposite the first longitudinal end portion of the bale.

6. The bale wrap monitoring system of claim 1, wherein the sensor signal is indicative of presence of the bale wrap on the bale and a number of layers of the bale wrap over the agricultural product of the bale, and the controller is configured to determine that the bale wrap is present on the bale in response to determining the number of layers of the bale wrap is equal to a target number of layers.

7. A bale wrap monitoring system for an agricultural harvester, comprising:
a sensor directed toward a bale of agricultural product within a baler of the agricultural harvester, wherein the sensor outputs a sensor signal indicative of presence of a bale wrap on the bale; and
a controller communicatively coupled to the sensor, wherein the controller comprises a processor and a memory, and the controller is configured to:
receive the sensor signal from the sensor;
determine the bale wrap is present on the bale based on feedback from the sensor; and
output a bale wrap presence signal in response to determining the bale wrap is present on the bale.

8. The bale wrap monitoring system of claim 7, comprising a sensor housing that supports the sensor within the agricultural harvester, wherein the sensor housing is disposed about a substantial portion of the sensor.

9. The bale wrap monitoring system of claim 7, wherein the sensor comprises an ultrasonic sensor, a color contrast sensor, a camera, an infrared sensor, a LiDAR sensor, or a combination thereof.

10. The bale wrap monitoring system of claim 7, wherein the bale wrap presence signal is indicative of instructions to control a user interface to present an indication that the bale wrap is present on the bale.

11. The bale wrap monitoring system of claim 7, wherein the bale wrap presence signal is indicative of instructions to control a bale ejection system to eject the bale from the baler of the agricultural harvester.

12. The bale wrap monitoring system of claim 7, comprising a second sensor that outputs a second sensor signal indicative of presence of the bale wrap on the bale, wherein the controller is configured to receive the second sensor signal from the second sensor, the sensor is directed towards a first portion of the bale, the second sensor is directed towards a second portion of the bale, separate from the first portion of the bale, and the controller is configured to determine the bale wrap is present on the bale based on feedback from the sensor and the second sensor.

13. The bale wrap monitoring system of claim 12, wherein the first portion is positioned at a first longitudinal end portion of the bale, and the second portion is positioned at a second longitudinal end portion of the bale, opposite the first longitudinal end portion of the bale.

14. The bale wrap monitoring system of claim 7, wherein the sensor outputs the sensor signal indicative of presence of the bale wrap on the bale and a number of layers of the bale wrap over the agricultural product of the bale, and the controller is configured to determine the bale wrap is present on the bale in response to determining the number of layers of the bale wrap is equal to a target number of layers.

15. The bale wrap monitoring system of claim 7, wherein the controller is configured to:
disable manual control of a bale ejection system with regard to ejecting the bale from the baler of the agricultural harvester; and
enable manual control of the bale ejection system with regard to ejecting the bale from the baler of the agricultural harvester in response to determining the bale wrap is present on the bale.

16. An agricultural harvester, comprising:
a baler;
a bale wrap feeder that feeds a bale wrap into a cavity of the baler at a feeding location; and
a bale wrap monitoring system, comprising:
a sensor directed toward a bale within the cavity of the baler, wherein the sensor outputs a sensor signal indicative of presence of the bale wrap on the bale; and
a controller communicatively coupled to the sensor, wherein the controller comprises a processor and a memory, and the controller is configured to:
receive the sensor signal from the sensor;
determine the bale wrap is present on the bale based on feedback from the sensor; and
output a bale wrap presence signal in response to determining the bale wrap is present on the bale.

17. The agricultural harvester of claim 16, wherein the sensor is disposed within the baler proximate to the feeding location, and the sensor is directed towards a portion of the bale immediately upstream of the feeding location with respect to a path of the bale wrap around the bale.

18. The agricultural harvester of claim 16, wherein the bale wrap monitoring system comprises a sensor housing that supports the sensor within the agricultural harvester, and the sensor housing is disposed about a substantial portion of the sensor.

19. The agricultural harvester of claim 16, wherein the bale wrap presence signal is indicative of instructions to control a user interface to present an indication that the bale wrap is present on the bale, to control a bale ejection system to eject the bale from the baler of the agricultural harvester, or a combination thereof.

20. The agricultural harvester of claim 16, wherein the bale wrap monitoring system comprises a second sensor that outputs a second sensor signal indicative of presence of the bale wrap on the bale, the controller is configured to receive the second sensor signal from the second sensor, the sensor is directed towards a first portion of the bale, the second sensor is directed towards a second portion of the bale, separate from the first portion of the bale, and the controller is configured to determine the bale wrap is present on the bale based on feedback from the sensor and the second sensor.
